(19) United States
(12) Patent Application Publication
(10) Pub. No.: US 2007/0036311 A1
(43) Pub. Date: Feb. 15, 2007

(54) Flow control in a communications network using a service cluster solution

(76) Inventors: Uwe Foll, Falkensee (DE); Albert Kain, Wien (AT)

Correspondence Address: Siemens Corporation;Intellectual Property Department, 170 Wood Avenue South, Iselin, NJ, 08830, US

(21) Appl. No.: 11/181,651

(22) Filed: Jul. 14, 2005

(51) Int. Cl. H04M 15/00

(52) U.S. Cl. 379/114.28

(57) ABSTRACT

An apparatus and method for use in a Gateway General Packet Radio Service Support Node (GGSN) located in a mobile network for processing subscriber services, and subscriber service charging data (SSCD), comprises gathering the subscriber service charging data (SSCD) in the Gateway General Packet Radio Service Support Node (GGSN), distributing the subscriber services and subscriber service charging data (SSCD) to a subsidiary system which processes the gathered subscriber services and subscriber service charging data (SSCD) and then in turn the processed subscriber service charging data (SSCD) is transmitted to a network element. Preferably, the method distributes the subscriber services and subscriber service charging data (SSCD) by relating each one of the plurality of subscribers to the gathered subscriber service and subscriber service charging data (SSCD) with a parameter transmitted with the subscriber service charging data (SSCD).

### FIELD OF THE INVENTION

The invention is used in communications networks to ensure that IP flows generated for executing subscriber services in a central unit to enable charging and billing in a centralised location and are load balanced.

### SUMMARY OF THE INVENTION

In today's communications networks, there exist numerous instances that can be used for generating billing data for the different services that a subscriber uses, such as the volume of data, the type of data contents, or the type of services that a subscriber uses. With the rapid increase in the number of subscribers and coupled with the fact that many of subscribers are mobile, it is necessary to create billing data throughout the network for the different subscribers and for the services they use.

Currently, the billing data is gathered with the use of filters that are located throughout the network. These filters are software implemented and are arranged to measure different predefined data such as the volume of data, the type of the data, the time duration of the service used and other metrics, in order to gather the data that is then used for billing the subscriber.

However, due to the fact that the data gathering is performed throughout the network, the generation of billing data is time consuming, as all the data has to be gathered and then correlated for each subscriber. Furthermore, the time that it takes to correlate all the data, causes the process of generating billing information to be inefficient and additionally it is limited by the computing power of the different network components that are charged with gathering the information.

A need, therefore, exists for a technique that can provide for an efficient way to correlate information and generate billing for subscribers as well as not being limited by the available computing power.

In one aspect of the invention, a method for use in a Gateway General Packet Radio Service Support Node (GGSN) located in a mobile network for processing subscriber service charging data (SSCD), comprises gathering the subscriber service charging data (SSCD) in the Gateway General Packet Radio Service Support Node (GGSN), distributing the subscriber service charging data (SSCD) to a subsidiary system which processes the gathered subscriber service charging data (SSCD) and then in turn the processed subscriber service charging data (SSCD) is transmitted to a network element. Preferably, the method distributes the subscriber service charging data (SSCD) by relating each one of the plurality of subscribers to the gathered the subscriber service charging data (SSCD) with a parameter transmitted with the subscriber service charging data (SSCD).

In another aspect of the invention, an apparatus used as a Gateway General Packet Radio Service Support Node (GGSN) in a mobile network and arranged to process subscriber service charging data (SSCD), comprises of a collecting unit that is arranged to gather the subscriber service charging data (SSCD), a load distribution unit arranged to distribute the subscriber service charging data (SSCD) to a subsidiary system for processing and a central processor unit arranged, when it receives the processed subscriber service charging data (SSCD) to transmit the subscriber service charging data (SSCD) to a network element. Preferably, the load distribution unit is arranged to distribute the gathered subscriber service charging data (SSCD) by relating each one of the plurality of subscribers to the gathered the subscriber service charging data (SSCD) with a parameter transmitted with the subscriber service charging data (SSCD).

Further advantages can be seen in the dependent claims, wherein a plurality of SSCD for each subscriber is gathered, thus enabling complete charging/billing data to be generated for each subscriber, wherein the parameter used comprises of a relationship relating a unique identification for each subscriber to a mobile connection reference, wherein the unique identification is a GCID, wherein the subsidiary system is part of the GGSN or is external to the GGSN, wherein the subsidiary system is a system comprising a group of elements forming a cluster comprising of central processing units providing processing power for the processing of the subscriber service charging data (SSCD).

The present invention will become more fully understood from the detailed description given hereinbelow and the accompanying drawings which are given by way of illustration only, and thus are not limitative of the present invention.

### BRIEF DESCRIPTION OF THE DRAWINGS

FIG. 1 shows a typical layout scheme for gathering subscriber service charging data (SSCD),

FIG. 2 shows a detailed view of the way in which subscriber service charging data (SSCD) is gathered,

FIG. 3a shows an illustrative embodiment of the proposed invention, and

FIG. 3b shows another illustrative embodiment of the proposed invention.

### DETAILED DESCRIPTION OF THE INVENTION

In mobile networks and in particular in the core side of the network, it has become customary to decompose the monolithic NNs (Network Nodes) into small and specialised network functions for reasons of efficiency and ease of management. In parallel, new service platforms, for example WAP-Gateways (Wireless Application Protocol-Gateways), MMS (Multimedia Messaging), IP (Internet Protocol) Portals, IMS (IP Multicore Network Subsystem) Services or Content Servers are being implemented within mobile networks.

As stated above, the information necessary for charging subscribers for the different services they use, is gathered with the use of filters that are located throughout the network in different NEs (Network Elements). However, with the increase of the number of services available to subscribers and the increase in the size of networks, it has become necessary to increase the number of NEs in order to gather charging information. Due to the increase of these NEs, the number of charging interfaces has also increased. Charging interfaces are selected points in the network where filters reside and gather data.

As stated above, due to the fact that the data gathering is performed throughout the network, the generation of billing data is time consuming, as all the data has to be gathered at the different NEs and then correlated for each subscriber. This increases the time it takes to correlate all the data on a permanent basis, causing the process of generating billing information to be inefficient, as the data is collected independently and in an unsynchronised fashion at each NE.

Correlation in the context of the invention disclosure is meant to comprise the aggregation, valuation and synchronisation of subscriber data collected from all relevant NEs that belong to the same communication service, which consists of bearer, service and/or content. This is in contrast to orthogonal charging, which is based on collecting data only from one point or NE in the network. Furthermore, correlation is applicable to both online and offline charging methods.

In the context of the invention disclosure, offline charging methods are processes where a CDR (Charging Data Record) is unidirectional delivered from NEs to a CGF (Charging Gateway Function) and/or CCF (Charging Collection Function) during and at the end of the used service and does not affect, in real-time, the service rendered.

In the context of the invention disclosure, online charging methods are processes that support real-time charging by using a bi-directional mechanism, which directly interacts between the charging and the session/service control.

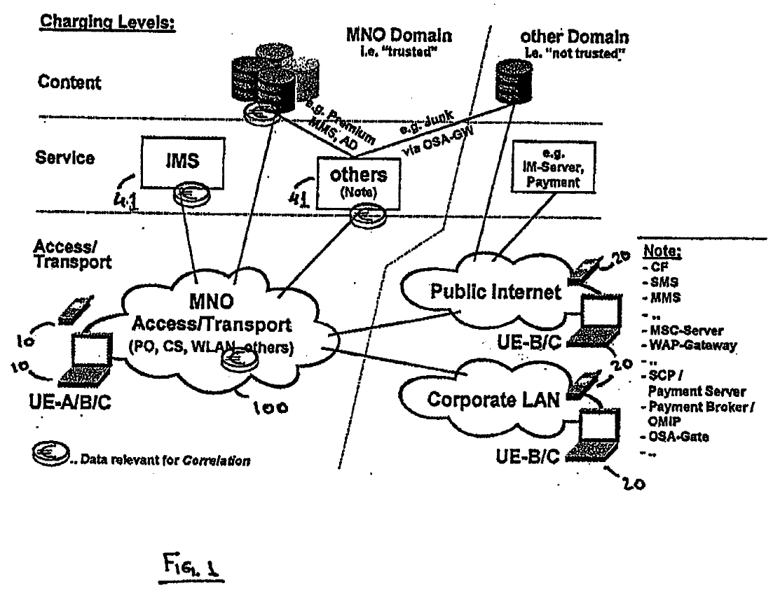

Furthermore, with respect to service the MNOs (Mobile Network Operators) provide three levels of service that can be distinguished in the access/transport level (e.g. the speed of access 56 kbps (kilobits per second)), the service level (e.g. MMS) and the content level (e.g. video clip). These levels can be combined, depending on how the MNO's wants to generate charging/billing data. As can be seen in FIG. 1, the gathering of data can be performed by an MNO on its own or in co-operation with third parties, and the data generated and afterwards correlated is done in every single service or charging level. As stated previously within the MNO's network different NEs also generate charging/billing data.

FIG. 1, further shows a MNO access/transport network 100 that allows a UE (User Equipment) 10, that can be a handheld cell phone or a laptop or another device (mobile and/or immobile) capable of requesting a setup for communicating over the network to another UE 20, located in another network such as a corporate LAN (Local Access Network) or the Internet or to another UE 20 located within the MNO network.

As it can be seen in FIG. 1, the domains that are formed by the different networks, are divided into different charging levels with respect to the service provided. The points at which data gathering is performed is indicated by the coin symbol. Within the access/transport level the charging/billing data is gathered by different NEs. At the service level, the data is gathered by an NE that acts as an IMS (IP Multicore Network Subsystem) 41 or by other NEs acting as other systems, such as MSC (Mobile Switching Centre) Server, WAP-Gateway, Payment Server, Payment Broker and so on. As it can also be seen the domain created by the MNO is a trusted domain, while other domains are not trusted.

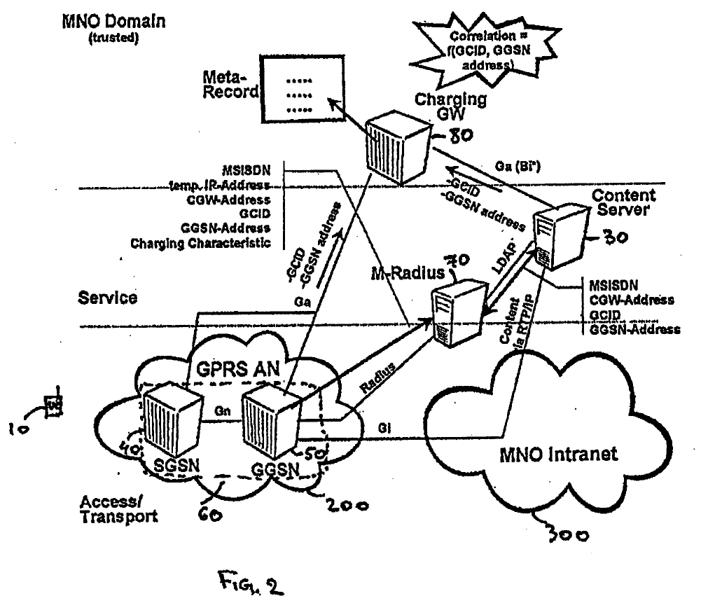

A more in depth explanation of the process in which charging/billing data is gathered is given through the aid of an illustrative example, as shown in FIG. 2. In order to aid the understanding of the process, only the trusted domain, (i.e. the MNO domain) as shown in FIG. 1, is going to be shown.

As seen in FIG. 2, a UE 10 accesses a content server 30 inside the trusted MNO domain via a GPRS (General Packet Radio Service) AN (access network) 200. The GPRS AN is coupled to an MNO Intranet 300. Both GPRS AN 200 and MNO Intranet 300 are comprised within the MNO access/transport network 100 shown in FIG. 1. The content server 30 is a NE that offers content to users, wherein the content is any type of multimedia stream or of an interactive application.

The GPRS AN comprises a SGSN (Serving GPRS Support Node) 40 and of a GGSN (Gateway GPRS Support Node) 50 which function as a GSN (GPRS Support Node) 60. The GGSN and the SGSN are coupled via a Gn interface, which is an interface between two GSNs. The GPRS AN 200 and MNO Intranet 300 are coupled via the Gi interface, which is the interface between the packet switched domain defined by the GPRS AN 200 and an external packet data network, in this case the MNO Intranet 300. The content server 30, is located beyond the Gi interface and so the entire GPRS network is considered as an access/transport network, that on top of bearer provisioning also has additional functions like mobility, charging etc.

The GPRS AN 200, both the SGSN 40 and the GGSN 50, and the content server 30 act independently in generating and registering charging/billing data depending on various criteria set by the MNO. These criteria can be volume of traffic, time duration of communication, type of service requested etc.

The data gathered is then generated as a CDR Charging Data Record). This data, from both the GPRS AN 200 and the content server 30, is then consolidated and correlated together in order to produce a unique set of charging/billing data.

Both the SGSN 40 and the GGSN 50 generate in the GRPS AN 200 charging/billing data for the transport of the content to and from the UE 10. A M-Radius (Remote Access Dial-In User Service) Server 70 authenticates the access to the MNO Intranet 300 domain. The M-Radius Server 70 also combines, on top of the standard AAA (Authentication, Authorisation, Accounting) functions, the MSISDN (Mobile Stations International PSTN/ISDN) subscriber identification and the temporary IP (Internet Protocol) address of the subscriber. During the PDP (Packet Data Protocol) context activation, the GGSN 50 provides the M-Radius server 70 with the MSISDN, a charging gateway 80 address, a GCID (GPRS Charging Identification) and charging characteristics by means of an Accounting start message. As stated in the 3^{rd} Generation Partnership Project (3GPP) Technical Specification (TS) 32.260 version 6.1.0 (2005-03) and incorporated herein by reference, the GCID holds the GPRS charging Identity which is generated by the GGSN for a GPRS PDP context. The M-Radius server 70 stores this information in a session profile. With the aid of a subscriber's IP (Internet Protocol) address some other NE such as the content server 30 can access the session profile using an LDAP (Lightweight Directory Access Protocol) interface.

As stated above, the SGSN 40 and the GGSN 50, and the content server 30 act independently in generating and registering charging/billing data depending on various criteria set by the MNO, as a CDR. The SGSN 40 and the GGSN 50 transmit their CDRs independently to a charging gateway 80, which is able to correlate corresponding entries using the GCID. The CDRs transmitted, over the Ga interface, which is the charging data collection interface between a CDR transmitting unit like a GGSN or SGSN and a CDR receiving functionality (CGF), contain the transferred volume for a specific PDP context, that is the transfer volume of different PDP contexts can be separated. The charging gateway 80, upon correlating the different CDRs, will then generate a metarecord containing the records of the correlated CDRs.

The content server 30 also generates CRDs for service usage and are sent to the charging gateway 80. The user is identified by the MSISDN, which is available from the LDAP interface) and the CDRs contain time and volume information.

The charging gateway 80 can then correlate both types of CDR using the GCID and generate charging/billing information. The relevant information of the subscriber such as charging gateway address, GCID, MSISDN, is retrieved by the content server 30 from the M-Radius server 70.

As stated previously, network services are spread throughout the MNO. This entails that numerous IP flows are generated as numerous NEs generate data. Also the fact that there is limited Processing Power available can cause problems when filtering the charging functions in order to generate the charging/billing info. The GCID can be lost for gathered data and then the data concerned will not be correlated. Thus charging/billing information is lost.

To overcome this drawback and in order to be able to generate charging data using all the available data gathered, the invention proposes to collect the required data using a centralised cluster thus distributing the computational load over several Central Processing Units (CPUs). The distribution is achieved by placing the necessary evaluation functions outside the GGSN 50 into a cluster system that is logically connected to the GGSN 50 and is related to the GCID.

Within the cluster system the reference linking the GCID to the data gathered is not assigned, like in current systems that collect billable data, according to the load distribution of the gathered data but according to the mobile connection reference for the subscriber having the connection and the existing GCID. This reference is also used as the unique reference for the cluster system. While the functions are centralised in the cluster system, like the GGSN 50, depending on the size of the MNO, the cluster is not a single element in the network but can also be distributed throughout the network outside of the GGSN but not visible as a distributed node in the network. Every mobile connection is identified by a unique PDP context and the GCID identifies this context. From the UE to the GGSN the connection is deemed a “closed connection”, that it is secure. This connection ends at the MNO network. By distributing the computational load to a cluster, the GGSN is freed from the limitation of processing power and so it can be possible to enable MNO functions in the GGSN, which is further advantageous as they can benefit from the closed connection. Furthermore, as the cluster will take into account the mobile connection reference for the subscriber having the connection and the existing GCID it is possible to identify and therefore generate charging/billing data for all the traffic of a particular subscriber without having to correlate all the gathered information in charging gateway 80,as it is currently done.

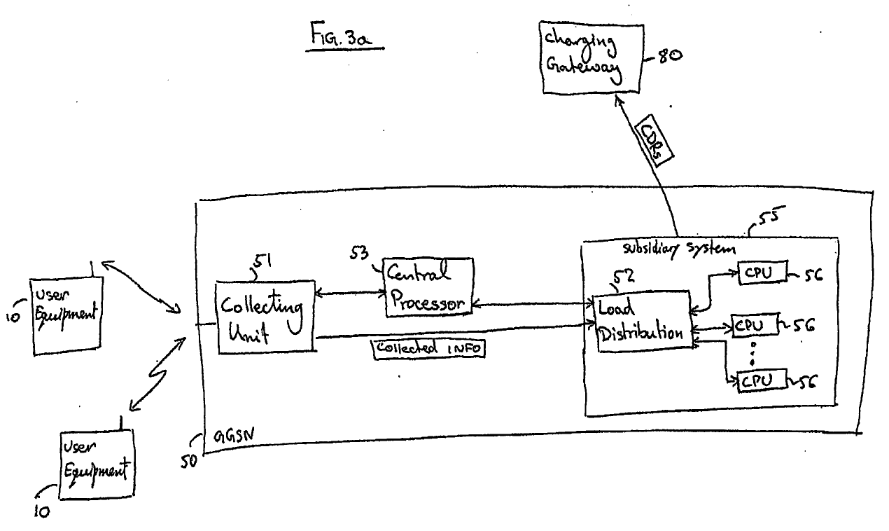

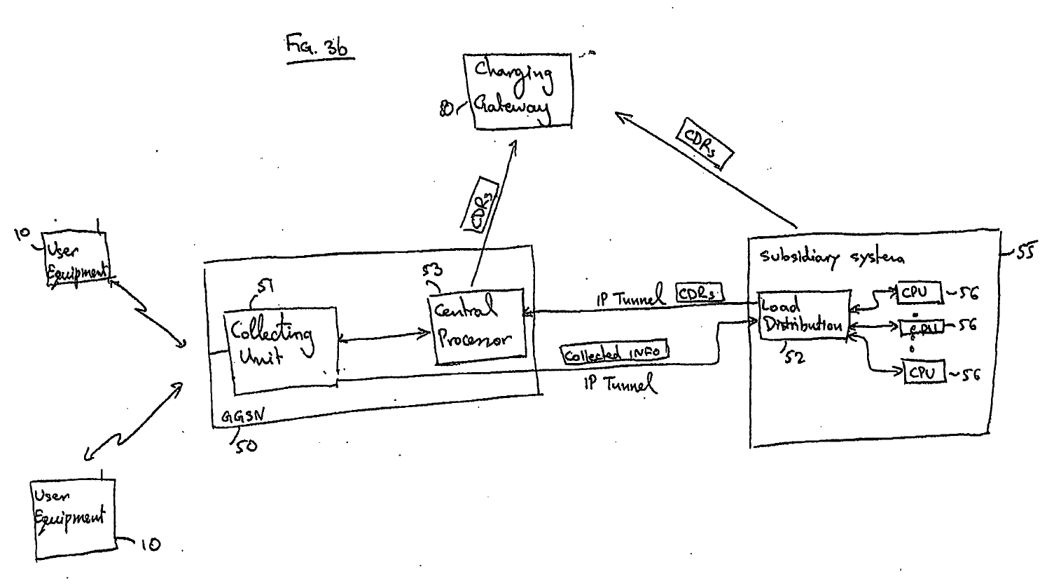

An illustrative embodiment of the proposed invention is shown in FIG. 3a. A GGSN 50, similar to the ones shown in FIGS. 1 and 2, has a collecting unit 51 arranged to collect the information needed from the UEs 10 that describe the mobile service call or session and is used by the UEs and the GSN to identify the session or call, that is the PDP context. This information collected comprises of QoS (Quality of Service) requirements, charging ID, GCID and so on.

The collecting unit 51 is further arranged to pass on all the collected information to a load distribution unit 52, which is part of a subsidiary system 55. The load distribution unit 52 is coupled to cluster elements comprising of numerous CPUs 56 that process the received information. These CPUs can be part of computers like Personal Computers (PCs) or the like that make up the cluster elements. The IP flow containing the collected information is routed via the load distribution unit 52 based on the PDP context and identified based on the GCID which is part of the ICID (IMS Charging Identifier). The load distribution unit 52 distributes the IP flow based on the specific GCID/PDP context associated to the information collected. With this distribution to the cluster, additional services can run in the cluster nodes. CDRs are then transferred from the subsidiary system 55 to the charging gateway as required in the 3GPP standard TS 32.240.

In this way, no data that is necessary for the generation of the charging/billing data is lost, as all the data for each subscriber is processed together and by distributing the load of data over numerous CPUs the data gathering becomes efficient the time taken to process the information is reduced, as well as reducing the correlation overhead when processing at the charging gateway 80.

As the subsidiary system 55 is part of the GGSN 50, the control of the subsidiary system 55 remains under the GGSN 50 in order to ensure that the distribution is properly effected. However, in an alternative illustrative embodiment shown in FIG. 3b, the subsidiary system 55 is removed from the GGSN 50. In this embodiment, the central processor 53, creates IP tunnels through the network so that the gathered data can be transmitted to the load distribution unit 52. The mechanism for the collecting of the data and the load distribution is the same as described in FIG. 3a. In this embodiment the cluster is controlled by the load distribution unit 52. As it can be understood in both embodiments, the subsidiary system which comprises of the cluster elements is a logical part of the GGSN. An advantage is that while it is part of the GGSN, it can be located within the GGSN or external to it, but still forming a logical part of the GGSN. Depending on the size of the network, the number of subscribers to name but two examples, a MNO can flexibly design the fashion by which SSCD is gathered. In this embodiment, the CDRs can be either transferred directly from the subsidiary system 55 to the charging gateway 80 or they can be transferred back to the GGSN 50 and from there to be transferred to the charging gateway 80.

The GPRS ID serves as the basis for the GCID and the GCID is the basis of all correlation functions and is permanently available and doesn't have to be provided at a later stage in the charging/billing process. Furthermore, as the GCID is used for all the services requested and used by a subscriber, the GCID is also used to monitor the cluster system 55, either from the GGSN 50 or from a network management station 90. Naturally, other subscriber references can be used as a basis for load distributing subscriber data.

An further advantage is that the CPUs performing the processing and correlation of the data can not be seen outside the cluster, that is their IP addresses are not viewable. This fact makes an attack from the outside, for example by a hacker, very difficult. Thus the control of the cluster and of the data being processed is maintained.

Although the invention has been described in terms of preferred embodiments described herein, those skilled in the art will appreciate other embodiments and modifications which can be made without departing from the scope of the teachings of the invention. All such modifications are intended to be included within the scope and spirit of the claims appended hereto.

1. A method for processing subscriber service charging data (SSCD) for a plurality of subscribers in a mobile network comprising the steps of:
gathering the SSCD in a-Gateway General Packet Radio Service Support Node (GGSN);
distributing the SSCD to a subsidiary system for processing; and
transmitting the processed SSCD to a network element, wherein
the distribution of the gathered SSCD is performed by relating each one of the plurality of subscribers to the gathered SSCD with a parameter transmitted with the SSCD.

2. The method according to claim 1, wherein a plurality of SSCD for each subscriber is gathered.

3. The method according to claim 1, wherein the parameter comprises of a relationship relating a unique identification for each subscriber to a mobile connection reference.

4. The method according to claim 3, wherein the unique identification is a GCID (GPRS Charging Identification).

5. The method according to claim 1, wherein the subsidiary system is part of the GGSN.

6. The method according to claim 1, wherein the subsidiary system is external to the GGSN.

7. The method according to claim 5, wherein the subsidiary system is a system comprising a group of elements forming a cluster.

8. The method according to claim 7, wherein the elements forming the cluster comprise of Central Processing Units.

9. The method according to claim 1, wherein the network element is a charging gateway.

10. An apparatus arranged to process subscriber service charging data (SSCD) for a plurality of subscribers in a mobile network comprising:
a collecting unit arranged to gather the SSCD;
a load distribution unit arranged to distribute the SSCD to a subsidiary system; and
a central processor unit arranged upon reception of the processed SSCD to transmit the SSCD to a network element, wherein
the load distribution unit is adapted to distribute the gathered subscriber service charging data by relating each one of the plurality of subscribers to the gathered SSCD with a parameter transmitted with the SSCD.

11. The apparatus according to claim 10, whereby the apparatus is a Gateway General Packet Radio Service Support Node (GGSN).

12. The apparatus according to claim 10, wherein a plurality of SSCD for each subscriber is gathered.

13. The apparatus according to claim 10, wherein the load distribution unit generates the parameter comprising a relationship relating a unique identification for each subscriber to a mobile connection reference.

14. The apparatus according to claim 13, wherein the unique identification is a GCID.

15. The apparatus according to claim 10, whereby the subsidiary system forms part of the GGSN.

16. The apparatus according to claim 15, whereby the subsidiary system is a system comprising of a group of elements forming a cluster.

17. The apparatus according to claim 16, whereby the elements forming the cluster comprise of Central Processing Units.

18. A mobile network comprising an apparatus according to claim 10.
